(19) United States
(12) Patent Application Publication
(10) Pub. No.: US 2002/0149706 A1
(43) Pub. Date: Oct. 17, 2002

(54) Retractable utility structure monitor

(75) Inventor: John B. Rosen, Eugene, OR (US)

Correspondence Address: Kolisch, Hartwell, Dicknson,, McCormack & Heuser, 200 Pacific Building, 520 S.W. Yamhill Street, Portland, OR, 97204, US

(73) Assignee: Rosen Products LLC.

(21) Appl. No.: 09/834,388

(22) Filed: Apr. 13, 2001

(51) Int. Cl. H04N 5/64

(52) U.S. Cl. 348/794

(57) ABSTRACT

A video display system comprising a utility structure having a top and a free edge with a slot recessed into that free edge. The system includes at least one guide rail configured to attach to the utility structure, typically within the slot. A movable carrier is configured to slide within the slot along the guide rail coplanar to the top surface. A display screen with a viewing surface is mounted on the carrier and is sized to fit within the slot. Typically, the display screen is pivotally mounted on the movable carrier to provide for deployment of the screen. First, the screen is deployed by translation of the screen and carrier along the guide rail between a stowed position and an intermediate position. Then, the display screen is pivoted about a first axis, typically parallel to an edge of the display screen, from the intermediate position to a deployed position wherein the viewing surface is presented above the horizontal surface for viewing in a generally vertical orientation. In the stowed position the display screen is contained within the slot in a generally horizontal orientation parallel to the top surface.

### TECHNICAL FIELD

The present invention relates to display monitors, and more particularly, to video display monitors that are retractably mounted in a location such as a table, counter top, work bench, etc.

### BACKGROUND

Video displays communicate both entertainment and information. Traditionally, the size and weight of video displays have limited the number of practical applications, largely because conventional tube-type video displays are heavy and require significant power to operate. It would be desirable to include a video display configured for storage within an edge of a table or counter, particularly in locations where space is limited. For example, such a video display would be useful in recreational vehicles, campers, buses and boats, where space is at a premium, but where video displays are often used.

Until recently, video displays designed for use where space is limited have employed cathode ray tube (CRT) displays, often making it necessary to use units that provide poor picture quality in order to conserve space. These small CRT units frequently have been placed in obscure locations that are not optimal for viewing. Additionally, traditional CRT units consume large amounts of energy, thus increasing the cost of operating the monitor.

Recent advances in video display technology, however, have led to dramatic improvements in smaller display units. Of particular importance is the advent of color liquid crystal displays (LCDs) and thin film transistor (TFT) displays that make it possible to display video in previously unavailable locations. Further advances in electronics have made it possible to separate some of the electronic circuitry from video displays, reducing the thickness of such displays even more. These video displays also have much lower energy requirements than traditional CRT displays, making them more practical in a wider variety of applications.

The present invention takes advantage of these improvements by providing a video display unit which can be stored horizontally within a tabletop, countertop or other table-like utility structure, providing considerable space savings. Additionally, the video display unit of the present invention provides a desirable viewing location, and preserves the tabletop, or countertop as a useful work surface.

### SUMMARY

The video display system of the present invention comprises a utility structure having a top surface and an edge with a slot recessed into that edge. The system includes at least one guide rail configured to attach to the utility structure, typically within the slot. A movable carrier is configured to slide within the slot along the guide rail coplanar to the top surface. A screen with a viewing surface is mounted on the carrier and is sized to fit within the slot.

Typically, the screen is pivotally mounted on the movable carrier to provide for deployment of the screen. The screen is deployed, first by translation of the screen and carrier along the guide rail between a stowed position and an intermediate position. Then, the screen is pivoted about a first axis, typically parallel to an edge of the screen, from the intermediate position to a deployed position wherein the viewing surface is presented above the horizontal surface for viewing in a generally vertical orientation. In the stowed position, the screen is contained within the slot in a generally horizontal orientation parallel to the top surface of the utility structure.

### BRIEF DESCRIPTION OF THE DRAWINGS

FIG. 1 is an isometric view of a utility structure with a video display system constructed in accordance with the present invention, a screen being shown in a deployed position.

FIG. 2 is an isometric view of the video display system of FIG. 1, the video display including a carrier frame, a screen, and a guide rail in accordance with the present invention.

FIG. 3 is an isometric view of the video display shown in FIG. 2, but with the screen in a stowed position.

FIG. 4 is an isometric view of the utility structure and video display shown in FIG. 1, but with the screen in the stowed position.

FIG. 5 is a partial sectional view of the utility structure and video display of FIG. 1, the screen being shown in the stowed position.

FIG. 6 is a partial sectional view of the utility structure and video display system of FIG. 5, the screen being shown in intermediate and deployed positions to illustrate deployment of the screen.

FIG. 7 is an isometric view of the utility structure and video display of FIG. 1, but showing an edge of the utility structure from which the screen deploys.

### DETAILED DESCRIPTION OF THE INVENTION

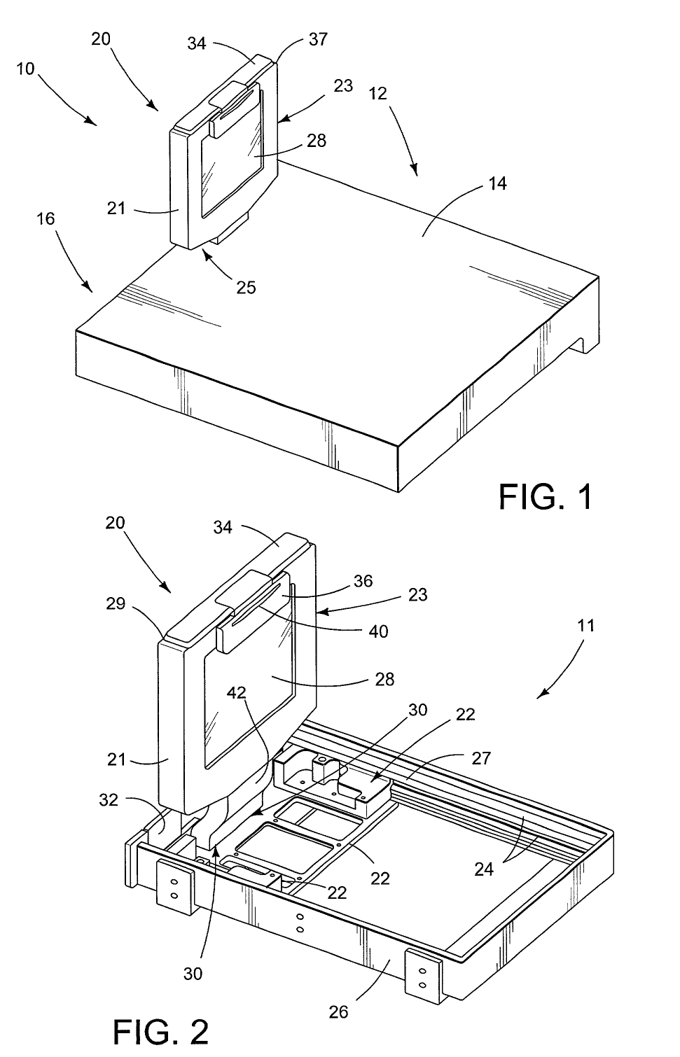

Referring initially to FIGS. 1-7, a video display system 10 is depicted, such video display system including a video display 11 mounted in a utility structure 12. As shown, utility structure 12 includes a horizontal top surface 14, and a free edge 16. Free edge 16 has a slot 18 recessed therein for receipt of video display 11. Video display 11 includes a display screen 20 pivotally mounted to a movable carrier 22, which is adapted to slide along guide rails 24. The guide rails typically are mounted within a frame 26, which is itself embedded in the free edge of utility structure 12. Screen 20 thus is capable of deployment through free edge 16 of utility structure 12, and pivots about an axis X which is generally parallel to the free edge so as to accommodate viewing.

Utility structure 12 can be a utility structure of any useful size, or may take the form of a tabletop, a countertop, a work bench top, a desktop, or any article of furniture that incorporates a generally horizontal top with a thickness suitable to house a video display such as that described herein. The term utility structure, herein, shall be used generally to refer to tabletops, countertops, bench tops, desktops, etc.

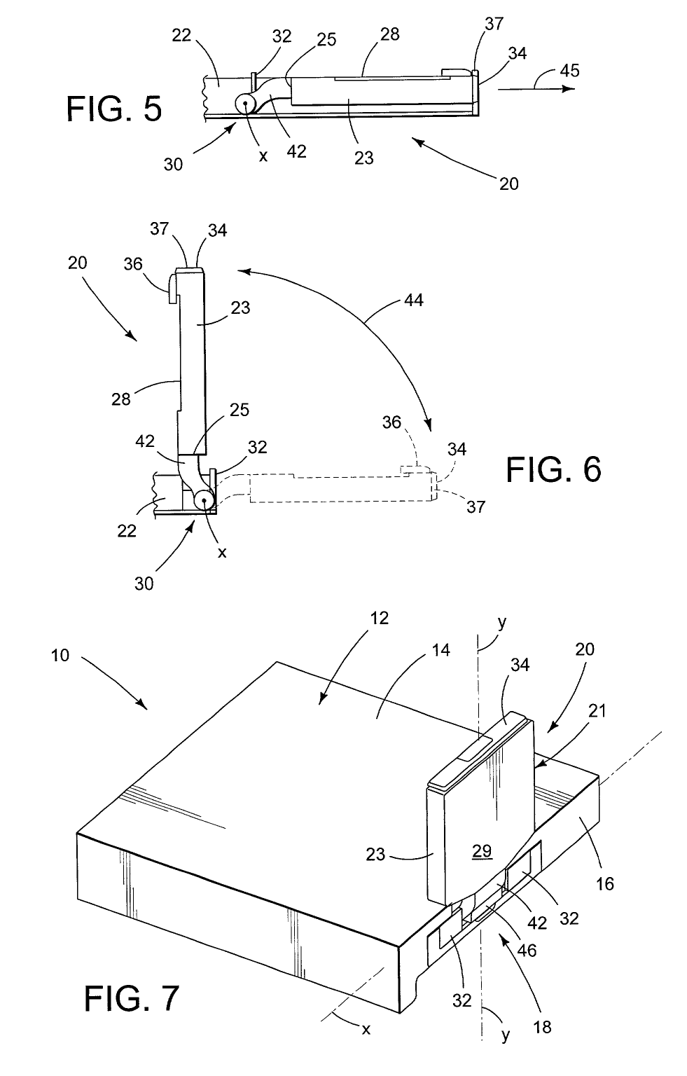

One useful application for the present invention is in the interior of a recreational vehicle or boat, where space is limited. It is necessary, however, that the tabletop have an exposed edge, or free edge from which the screen may be deployed. Utility structure 12, for example, includes free edge 16. A free edge, as used herein, is an edge that is not affixed to any other structure and has adequate adjacent free space to permit a screen to deploy in a manner depicted in FIGS. 5 and 6.

In the depicted embodiment, the utility structure defines a slot 18 configured to house video display 11. The video display, in turn, includes a frame 26 with a pair of guide rails 24. Typically, frame 26 will have rectangular dimensions with opposed, generally parallel side walls. Although frame 26 is depicted as a separate component, it will be appreciated that slot 18 itself may serve as a frame. Accordingly, although guide rails 24 are shown along the side walls of fixed frame 26, the present limited to, one or more guide rails mounted directly to the utility structure.

As noted above, the thickness of utility structure 12 must be sufficient so as to accommodate receipt of a display screen. Slot 18 may be configured such that the bottom of the slot is free or open, or may be configured to define upper and lower surfaces between which the video display is received. The screen may be of any type, but preferably will take the form of a flat panel display screen, such as a liquid crystal display (LCD) screen or a thin film transistor (TFT) display screen.

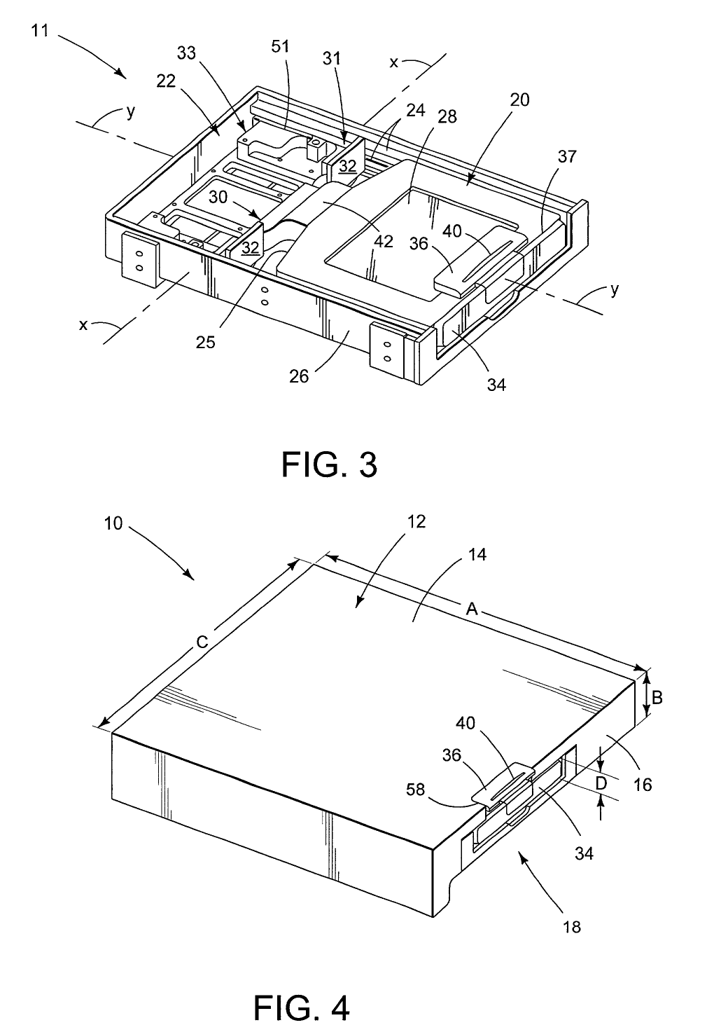

Focusing now on FIGS. 2 and 3, it will be noted that movable carrier 22 includes grooves 27 adapted to engage and slide along guide rails 24 of frame 26 for horizontal deployment of screen 20. Movable carrier 22 thus is configured to cooperatively engage guide rails 24. Movable carrier 22 includes a front end 31, a rear end 33, and two opposed sides 51. Rear end 33 is opposed to front end 31, with the two opposed sides extending between the front and rear ends. Front end 31 typically is oriented for selected placement adjacent to free edge 16. Upon deployment of the display screen, front end 31 typically is flush with free edge 16.

Display screen 20 is pivotally mounted to movable carrier 22 via a hinge structure such as that shown generally at 30 in FIGS. 2 and 3. The hinge structure defines the axis X, which typically is generally parallel to free edge 16, and typically is generally parallel to a bottom edge of screen 20.

In the depicted embodiment screen 20 includes parallel sides 21 and 23. Screen sides 21 and 23 are oriented perpendicular to the axis X of the hinge structure. Screen 20 also includes a bottom edge 25, adjacent to hinge structure 30, and a generally planar top edge 37, distal from the hinge structure. Screen 20 is illustrated in the deployed position in FIG. 2, where the video display is depicted in isolation. Conversely, in FIG. 3, screen 20 is shown in the stowed position, the video display again being depicted in isolation. The screen further includes a viewing surface 28 that may be presented for viewing in an area above top surface 14 of utility structure 12. The screen also includes a back surface 29 opposite the viewing surface.

Movable carrier 22 includes an edge plate 32 that is adapted to lie substantially flush with free edge 16 when screen 20 is deployed. Edge plate 32 is located adjacent front end 31 of movable carrier 22. Hinge structure 30 incorporates a rear surface portion 46 that aligns with edge plate 32 to substantially conceal slot 18 when display screen 20 is in the deployed position.

Referring to FIGS. 3 and 4, it will be appreciated that screen 20 incorporates an edge plate 34 on top edge 37. Edge plate 34 lies substantially flush with free edge 16 when the screen is in the stowed position, thus concealing slot 18. The screen may further include a tab 36, typically located adjacent top edge 37 of screen 20, to release a spring-biased catch when deploying the screen. Correspondingly, utility structure 12 may include a notch 38 adjacent to free edge 16 and centered above slot 18. As indicated, notch 38 may be sized to receive tab 36 of screen 20 and may be sized to accommodate receipt of a support arm 42 (FIG. 7). A grip ridge 40 on tab 36, provides a place to grip the screen for moving the screen from the stowed position out to an intermediate position. The screen then may be rotated about axis X into the deployed position.

Referring to FIGS. 5 and 6, the deployment operation of screen 20 is disclosed. In FIG. 5, screen 20 is in the stowed position. In the stowed position, the screen is substantially contained within slot 18 in a generally horizontal orientation, coplanar with horizontal top surface 14. To deploy the screen, a force is applied to grip ridge 40 of tab 36. This force is applied horizontally, in a direction extending from utility structure 12 toward a free space adjacent to free edge 16. This is the direction indicated generally by arrow 45 in FIG. 5. Screen 20 thus is pulled out of slot 18 in a transverse direction to a point where edge plate 32 of movable carrier 22 is substantially flush with edge 16. (As shown by the dashed lines in FIG. 6.) In this extended, or intermediate position, the screen is still in a generally horizontal orientation.

Thereafter, screen 20 is rotated about axis X, which typically is parallel to free edge 16, into a generally vertical orientation as illustrated in FIG. 6. The double-headed directional arrow 44 shown in FIG. 6 indicates both downward and upward folding of display screen 20 about axis X using hinge structure 30. Hinge structure 30 is a frictional type hinge that is able to maintain screen 20 in any selected position along the rotational path. As a result, if optimal viewing is achieved at some angle between vertical and horizontal, the viewing surface can be adjusted to the selected optimal viewing angle. The frictional hinge structure 30 will hold the screen at the selected angle. Similarly, the hinge may be configured to provide for pivot of the screen beyond the vertical position to accommodate an optimal viewing position.

As indicated above, movable carrier 22 and display screen 20 incorporate edge plates 32, 34 that are designed to align flush with free edge 16 when the screen is in the deployed or stowed position. In the deployed position, edge plate 32 of movable carrier 22 aligns substantially flush with free edge 16. In the stowed position, edge plate 34 of screen 20, which is attached at top edge 37, aligns substantially flush with free edge 16. The flush alignment of edge plates 32 and 34 is not only aesthetically pleasing, but acts to prevent dust and other particulate debris from entering slot 18. Limiting the contamination in slot 18 enhances durability of the video display.

Referring once again to FIG. 4, it will be appreciated that support arm 42 connects the screen to hinge structure 30 adjacent bottom edge 25 and provides structural support to the display screen in the deployed position. Although not specifically depicted, it will be appreciated that hinge structure 30 may be configured to accommodate rotation of the screen both about a first axis X that is perpendicular to sides 21, 23 and a second axis Y that is parallel to sides 21, 23. This support arm enables the screen to rotate side-to-side in the deployed position for an optimal viewing angle. This second axis of rotation Y is transverse to the first axis X about which screen 20 pivots when rotating about hinge structure 30. Alternatively, the video display system 10 may include dual hinge arrangements that permit rotation about axes X and Y.

FIG. 7 depicts another view of utility structure 12 and video display system 10, the screen being shown in the deployed position. It will be noted from this perspective that free edge 16 forms a substantially flush surface with edge plate 34 of the movable carrier. A rear surface portion 46 of hinge structure 30 aligns substantially flush with free edge 16 when screen 20 is in the deployed position. This rear surface portion 46 and edge plate 34 combine to prevent airborn dust and particles from entering slot 18.

In the depicted embodiment, utility structure 12, has a length A, a depth C, and a thickness B (FIG. 4). Screen 20 has a thickness D, as shown in FIG. 3. To accommodate video display 11, utility structure 12 has a minimum thickness B that is greater than the thickness D of screen 20. In the depicted embodiment, the thickness of utility structure 12 is measured in the vertical direction along free edge 16. The thickness measurement of screen 20 is adjacent top edge 37 in the direction of the shorter dimension. By providing a thickness B greater than thickness D of screen 20, horizontal surface 14 remains intact above slot 18, providing protection to viewing surface 28.

While the present invention has been shown and described with reference to the foregoing operational principles and preferred embodiment, it will be apparent to those skilled in the art that other changes in form and detail may be made therein without departing from the spirit and scope of the invention as defined in the appended claims.

I claim:

1. In a utility structure having a horizontal top surface and a free edge with a slot recessed into the edge, a video display comprising:
at least one guide rail configured to operatively attach to the utility structure within the slot;
a movable carrier configured to slide within the slot along the guide rail in a plane generally parallel to the top surface; and
a display screen with a viewing surface, wherein the display screen is sized to fit within the slot, the display screen being pivotally mounted on the movable carrier to provide for deployment of the display screen first, by translation of the display screen and carrier along the guide rail between a stowed position wherein the display screen is contained within the slot in an orientation generally parallel to the top surface and an intermediate position wherein the display screen is still in the generally parallel orientation, and second, by pivot of the display screen about a first axis parallel to the edge from the intermediate position to a deployed position for viewing.

2. The video display of claim 1, wherein the movable carrier includes an edge plate mounted on a front end configured to lie substantially flush with the free edge of the utility structure, thereby covering the slot when the display screen is in the deployed position.

3. The video display of claim 1, wherein the display screen includes a top edge configured to lie substantially flush with the free edge of the utility structure, thereby covering the slot when the display screen is in the stowed position.

4. The video display of claim 1, wherein the display screen pivots about a second axis transverse to the first axis.

5. The video display of claim 1, wherein the video display screen is a flat panel display.

6. The video display of claim 5, wherein the flat panel display is a liquid crystal display.

7. The video display of claim 6, wherein the flat panel display is a thin-film-transistor display.

8. A video display system comprising:
a utility structure top having an upper surface and an edge with a slot formed into the edge of the utility structure top;
at least one guide rail mounted within the slot;
a movable carrier adapted to travel along the guide rail within the slot; and
a display screen having a predetermined thickness less than that of the utility structure top, a viewing surface, a first edge, and a hinged second edge opposed to the first edge, the second edge being pivotally mounted on the movable carrier within the slot to provide for deployment of the display screen first, by translation of the display screen and movable carrier along the guide rails between a stowed position wherein the free edge of the display screen lies flush with the free edge of the utility structure top and the display screen is generally oriented co-planar with the upper surface of the utility structure top, and an intermediate position, wherein the display screen extends out of the slot and a plate end of the movable carrier lies flush with the free edge of the utility structure top, and second, by pivot of the display screen about a first axis parallel to the free edge of the utility structure top from the intermediate position to a deployed position wherein the display screen is in an orientation with the viewing surface presented for viewing.

9. The video display system of claim 8, wherein the movable carrier includes a free edge plate mounted on a front end of the movable carrier, and configured to lie substantially flush with the free edge of the utility structure, thereby covering the slot when the display screen is in the deployed position.

10. The video display system of claim 8, wherein the vertical thickness of the free edge of the utility structure top is less than approximately 1¾ inches.

11. The video display system of claim 8, wherein the video display screen pivots about a second axis transverse to the first axis.

12. A video display system comprising:
a utility structure having a horizontal top surface and an edge of a predetermined thickness with a slot formed therein, the slot defining opposed sides;
a frame mounted to the utility structure within the slot and having a pair of guide rails oriented along the opposed sides of the slot;
a movable carrier adapted to travel along the guide rails of the frame within the slot, the movable carrier being sized to fit within the slot; and
a display screen having a thickness less than a thickness of the utility structure, the display screen including a viewing surface, wherein the display screen is pivotally mounted on the movable carrier to provide for deployment of the display screen first, by translation of the display screen and movable carrier along the guide rails from a stowed position, wherein the display screen and carrier are substantially within the slot in a generally horizontal orientation coplanar to the horizontal top surface to an intermediate position wherein the display screen is still in a generally horizontal orientation, and second, by pivot of the display screen about a first axis parallel to the edge from the intermediate position to a deployed position wherein the viewing surface is presented for viewing in a generally vertical orientation.
